(19) United States
(12) Patent Application Publication
(10) Pub. No.: US 2026/0351446 A1
(43) Pub. Date: Nov. 5, 2026

(54) RF CABLE WITH DIELECTRIC STRUCTURE FOR REDUCED INSERTION LOSS

(71) Applicant: JOHN MEZZALINGUA ASSOCIATES, LLC., Liverpool, NY (US)

(72) Inventors: Thomas Sawyer URTZ, North Syracuse, NY (US); Brandon STEVENS, Liverpool, NY (US); Christopher NATOLI, Baldwinsville, NY (US); Shawn CHAWGO, Phoenix, NY (US)

(21) Appl. No.: 19/099,721

(22) PCT Filed: Oct. 15, 2024
(86) PCT No.: PCT/US2024/051329

§ 371 Date: Jan. 29, 2025

Related U.S. Application Data
(60) Provisional application No. 63/590,950, filed on Oct. 17, 2023.

(51) Int. Cl. H01B 11/18; H01B 3/30

(52) U.S. Cl. CPC H01B 11/1834; H01B 3/307; H01B 11/1817; H01B 11/1895

(57) ABSTRACT

An RF coax cable comprises an inner conductor; an outer conductor; and a dielectric structure disposed between the inner conductor and the outer conductor, the dielectric structure having an inner sleeve and three ribs, the ribs having an inner thickness proximate to the inner sleeve and an outer thickness proximate to an inner surface of the outer conductor, the inner thickness being greater than the outer thickness. The dielectric structure provides for reduced insertion loss by dissipating less energy in the cable, while maintaining structural integrity.

### BACKGROUND OF THE INVENTION

Coaxial RF (Radio Frequency) cables used in cellular communications have highly demanding requirements for signal quality. This is particularly true for coax RF cables that connect cellular base stations to antennas at the tops of cell towers. One of the key parameters for these cables is insertion loss, which must be kept to a minimum. Conventional approaches to reducing insertion loss is to minimize the amount of dielectric material (typically plastic) between the coax cable's inner conductor and outer conductor. One problem with this approach is that it undermines the structural integrity of the cable. Another problem with this approach is that it makes coreing extremely difficult. Coreing is the act of removing a section of dielectric (roughly 2/10 inch) from the end of the coax cable so that a connector may be installed. If the dielectric is too flimsy, it disintegrates in the act of coreing.

Accordingly, what is needed is a coax RF cable that has a robust dielectric that has good structural integrity while still minimizing insertion loss.

### SUMMARY OF THE INVENTION

An aspect of the disclosure involves a coax cable. The coax cable comprises an inner conductor; and outer conductor; and a dielectric structure disposed between the inner conductor and the outer conductor, the dielectric structure having an inner sleeve and three ribs disposed on the inner sleeve, the ribs having an inner thickness proximate to the inner sleeve and an outer thickness proximate to an inner surface of the outer conductor, the inner thickness being greater than the outer thickness.

Another aspect of the disclosure involves a coax cable having an inner conductor and an outer conductor coaxially aligned with the inner conductor. The coax cable also has a dielectric structure comprising an inner sleeve, disposed over an outer surface of and coaxially aligned with the inner conductor, and at least three ribs, each of which protrudes from the inner sleeve to an inner surface of the outer conductor. Further, each of the ribs has an inner width and an outer width perpendicular to a longitudinal axis of the coax cable, where the inner width is greater than the outer width.

### BRIEF DESCRIPTION OF DRAWINGS

FIG. 1 illustrates an exemplary coax cable assembly according to the disclosure.

FIG. 2 is a view of the coax cable assembly of FIG. 1 along its longitudinal axis.

FIG. 3 is a view of the coax cable assembly of FIG. 1 from a side, orthogonal to the longitudinal axis.

### DETAILED DESCRIPTION OF THE INVENTION

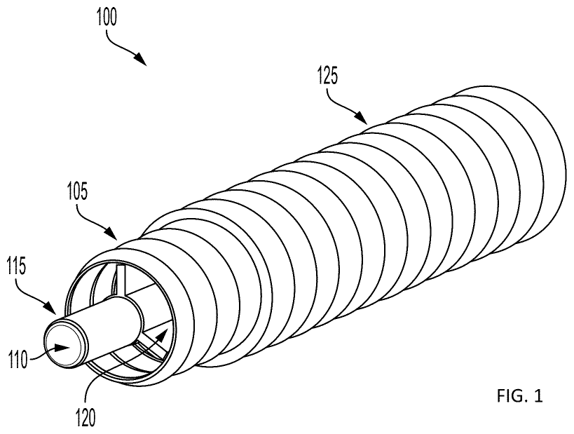

FIG. 1 illustrates an exemplary coax cable 100 according to the disclosure. Coax cable assembly 100, which may be a ½ inch cable, has an outer conductor 105, which may have an annular structure. Coaxial to outer conductor 105 is inner conductor 110, which may be formed of aluminum. Surrounding inner conductor 110 is a copper cladding 115. Surrounding copper cladding 115 is a dielectric structure 120, which maintains coaxiality between inner conductor 110 and outer conductor 105. Disposed on an outer surface of outer conductor 105 is a jacket 125, which may be formed of plastic.

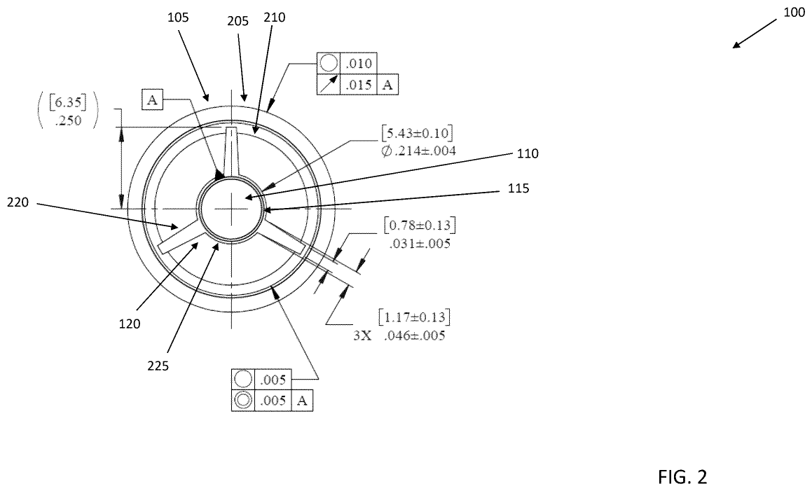

FIG. 2 is a view of the coax cable assembly 100 along its longitudinal axis but without jacket 125. Outer conductor 105, given its annular structure, as a peak diameter 205 and a valley diameter 210. In this exemplary embodiment, the peak diameter 205 is 0.543+/−0.008 inch (13.8+/−0.2 mm), and the valley diameter 210 is 0.481+/−0.008 inch (12.2+/−0.2 mm). Outer conductor 105 may be formed of aluminum, copper, or other suitably conductive material. In an exemplary embodiment, outer conductor may be formed of a thin strip of copper that is rolled into a cylinder and welded to form a pipe, which is then corrugated to form the annular structure. Further to this example, the copper may have a thickness of 0.008 inch (−0.2 mm) .

Also shown is inner conductor 110, which in this example has a diameter of 0.1974+1−0.001 inch (5.01+/−0.03 mm). Disposed on the outer surface of inner conductor 110 is copper cladding 115, which may have a thickness of 0.007+/−0.002 inch (0.18+/−0.05 mm).

Dielectric structure 120 has an inner sleeve 225 that is disposed on the copper cladding 115, and three ribs 220 that protrude from inner sleeve to make contact with the inner surface of outer conductor 105. Each rib 220, in this exemplary embodiment, has an inner thickness—where it is integrated with inner sleeve 225—of 0.046+/−005 inch (1.17+/−0.13 mm) and an outer thickness—where it contacts the inner surface of outer conductor 105 of 0.031+/−0.005 inch (0.78+/−0.13 mm). It will be understood that more than three ribs are possible and within the scope of the present invention.

Dielectric structure 120 may be formed of PE (Polyethylene) having a dielectric constant of 2.3. In an alternative embodiment, dielectric structure 120 may be formed of FEP (Fluorinated Ethylene Propylene), which has a dielectric constant of 2.1, or PTFE (Polytetrafluoroethylene), which has a dielectric constant of 2.02. In an exemplary embodiment in which FEP is used for dielectric structure 120, the diameter of inner conductor 110 may be increased. Increasing the diameter of inner conductor 110 reduces insertion loss by reducing the amount of energy dissipated by inner conductor 110 relative to the exemplary embodiment above using 2 polyethylene. The dimensions of dielectric structure 120 would be adjusted accordingly. It will be understood that such variations are possible and within the scope of the disclosure.

With dielectric structure 120 having three ribs with the exemplary thicknesses, dielectric structure 120 has sufficient structural integrity to maintain coaxiality between inner conductor 110 and outer conductor 105 and to enable coreing (for example, to a depth of 0.17 inch along the longitudinal axis) without the dielectric material disintegrating, while having a low enough volume of dielectric material to maintain a proper energy dissipation within cable assembly 100 to provide a tolerable insertion loss. For example, the disclosed thicknesses of dielectric structure 120 enable coreing (shearing and removing the dielectric) to be done without leaving excess material behind or compressing the dielectric.

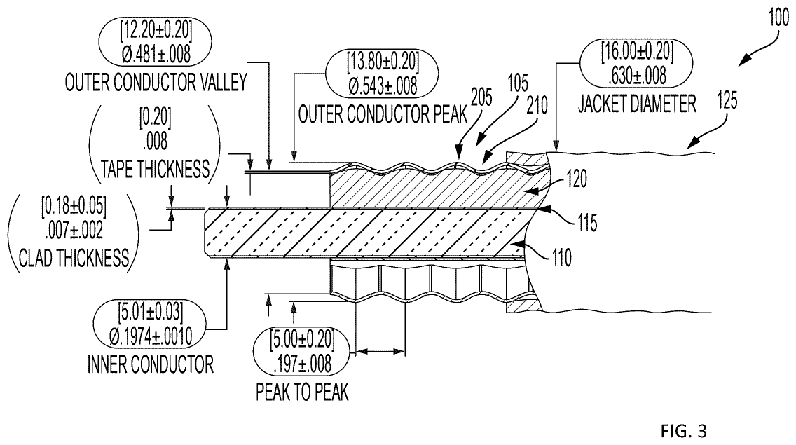

FIG. 3 is a view of the coax cable assembly 100 from a side, orthogonal to the longitudinal axis. Illustrated are inner conductor 110, copper cladding 115, dielectric structure 120, outer conductor 105, and jacket 125.

1. A coax cable, comprising:
an inner conductor;
an outer conductor; and
a dielectric structure disposed between the inner conductor and the outer conductor, the dielectric structure having an inner sleeve and three ribs disposed on the inner sleeve, the ribs having an inner thickness proximate to the inner sleeve and an outer thickness proximate to an inner surface of the outer conductor, the inner thickness being greater than the outer thickness.

2. The coax cable of claim 1, further comprising a copper cladding disposed on an outer surface of the inner conductor.

3. The coax cable of claim 1, wherein the dielectric structure comprises polyethylene.

4. The coax cable of claim 1, wherein the dielectric structure comprises fluorinated ethylene propylene.

5. The coax cable of claim 1, wherein the outer conductor comprises an annular structure.

6. A coax cable, comprising:
an inner conductor;
an outer conductor coaxially aligned with the inner conductor; and
a dielectric structure comprising an inner sleeve, disposed over an outer surface of and coaxially aligned with the inner conductor, and further comprising at least three ribs,
wherein each of the at least three ribs protrudes from the inner sleeve to an inner surface of the outer conductor, and
wherein each of the at least three ribs has an inner width and an outer width perpendicular to a longitudinal axis of the coax cable, the inner width being greater than the outer width.

7. The coax cable of claim 6, further comprising a copper cladding disposed between the outer surface of the inner conductor and the inner sleeve of the dielectric structure.

8. The coax cable of claim 6, wherein the dielectric structure comprises polyethylene.

9. The coax cable of claim 6, wherein the dielectric structure comprises Fluorinated Ethylene Propylene.

10. The coax cable of claim 6, wherein the dielectric structure comprises polytetrafluoroethylene.

11. The coax cable of claim 6, wherein the inner width of each of the three or more ribs is preferably in the range of 1.04 mm to 1.3 mm, and the outer width of each of the three or more ribs is preferably in the range of 0.65 mm to 0.91 mm.

12. The coax cable of claim 6, wherein the inner width and outer width of each of the three or more ribs is based on the material composition of dielectric structure.
